(19) United States
(12) Patent Application Publication
(10) Pub. No.: US 2006/0155709 A1
(43) Pub. Date: Jul. 13, 2006

(54) Method and system for operating a web based service

(76) Inventor: Albert Lewis Harlow, Chagrin Falls, OH (US)

Correspondence Address: Thomas E. Kocovsky, Esq.;Fay, Sharpe, Fagan, Minnich & McKee, LLP, Seventh Floor, 1100 Superior Avenue, Cleveland, OH, 44114-2579, US

(21) Appl. No.: 11/298,791

(22) Filed: Dec. 9, 2005

Related U.S. Application Data
(60) Provisional application No. 60/634,618, filed on Dec. 9, 2004.

(51) Int. Cl. G06F 7/00; G06F 17/30

(52) U.S. Cl. 707/10

(57) ABSTRACT

A web based services to create and manage contact information is disclosed. The contact information is integrated with a web based literature creation and direct mailing service. A subscriber accesses the home page of the web based literature creation and direct mailing service by using a computer with an electronic connection to the appropriate server. After a subscriber is successfully logged in, the subscriber can access a contacts manager module, a services module, and a mailing list module to create, view and deliver direct-mail pieces to people or businesses selected via the mailing list module.

### BACKGROUND OF THE INVENTION

This application claims priority to and the benefit of U.S. Provisional Application No. 60/634,618, filed Dec. 9, 2004, which application is incorporated herein by reference in its entirety.

The present invention relates to web based services to create and manage contact information. The present invention also relates to web based services to create and deliver direct-mail pieces.

Currently, job seekers prepare resumes or have them prepared. Paper copies of the resumes are placed in an envelope, addressed to a contact or a prospective company and mailed. To reach a wider audience, some job seekers subscribe to a mailing list service that supply mailing labels to the personnel manager or other generic recipient of companies in selected fields.

Other job seekers post resumes on web sites to be viewed by potential employees. Some email a generic resume to long lists of personnel managers. Often such generic unsolicited resumes do not receive the attention that is received by a paper resume with a personal cover letter.

Web services are available for literature printing, but currently provide only a narrow spectrum of services/products. For example, a promotional literature mailing to a potential customer mailing list is accomplished by a plurality of service providers that need to be coordinated. A mail list service provider, provides mailing lists. A literature designer generates the copy. A printer prints the copy and may also provide mailing services. One problem with literature designed on a computer and communicated electronically to the printer is that the literature printed by a copy or print shop may differ from the original design. Electronic literature commonly changes appearance or formation with the software, software settings, and printers used to view it. The multiple suppliers of products and services required for a literature mailing add additional cost.

There is a need for an electronically integrated direct-mail system to reduce costs associated with direct resume and other mailings and improve the quality of such mailings.

### SUMMARY OF THE INVENTION

In accordance with one aspect of the invention, a method of operating a web based system to manage a subscriber's contact is provided. The method includes managing a subscriber's personal and business contacts by accessing a contacts manager web page, wherein the contacts web page provides the subscriber with contact information.

In another aspect of the invention, a method of operating a web based system to deliver a direct-mail piece is provided. The method includes a subscriber logging on to the home page of a web based system, building a mailing list from a mailing list web page accessed from the home page, building literature from a literature building web page accessed from the home page or the mailing list web page, displaying the created literature as an exact replica of the printed literature, and electronically sending a merged mailing list and literature file to a print shop.

In another aspect of the invention, a web based system to create a direct-mail piece is provided. The web based system including a means for communicating from a subscriber computer to a server computer that includes a home page, a means for a subscriber to login from the home page to the web based system, a means for the web based system to create and deliver a direct-mail piece to a person or business, and a means for the web based system to provide a subscriber with a computer display of an exact replica of a direct-mail piece to be delivered. The web based system further includes a contacts manager module, a services module and a mailing list module.

In another aspect of the invention, a web based system to create a direct-mail piece is provided. The web based system including a home page accessible from a subscriber's computer, a means for a subscriber to login from the home page to the web based system to create, view and deliver literature, a means for a subscriber to build a mailing list including names and addresses, a means for creating literature and electronically sending the created literature to the subscriber for display, and a means initiated by the subscriber for sending the created literature electronically for printing literature as displayed.

In another aspect of the invention, a method of operating a web based system to deliver a direct-mail piece is provided. The method including a subscriber logging on to the home page of a web based system, building a mailing list by selecting an icon on the home page and accessing a mailing list web page; entering search criteria information within fields of the mailing list web page to generate a list of prospective employers including names and addresses; building a resume by selecting an icon on the home page or mailing list web page and accessing a resume building web page, selecting or uploading a resume template from the resume building web page; entering information to be printed on the resume by accessing a web page from the resume building web page, and displaying the resume as constructed from the template and entered information, the displayed resume being an exact replica of the printed resume, before the resume is printed; building a cover letter by selecting an icon on the home page, the mailing list web page, or the resume builder web page, and accessing a cover letter building web page; selecting a cover letter template from the cover letter building web page; entering information to be printed on the cover letter; selecting an envelope message to be printed on the envelope of the cover letter; creating or uploading a signature file and entering this file to be printed on the cover letter; displaying the cover letter and envelope as constructed from the template and entered information, the displayed cover letter being an exact replica of the printed cover letter and envelope, before the cover letter and envelope are printed; building a business card by selecting an icon on the home page, the mailing list web page, the resume builder web page or the cover letter builder web page, and accessing a business card building web page; selecting a business card template from the business card building web page; entering information to be printed on the business card; displaying the business card as constructed from the template and entered information, the displayed business card being an exact replica of the business card, before the business card is printed; printing resumes, cover letters and business cards by selecting an icon from the home page, the mailing list web page, the resume builder web page, the cover letter builder web page or the business card building page, and accessing a checking out web page; and mailing or delivering the resumes, cover letters and business cards to the names and addresses listed on the mailing list.

One advantage of the present invention is a reduction in costs associated with the creation and delivery of a direct-mail piece.

Another advantage resides in eliminating the need to coordinate multiple suppliers of services.

Another advantage is that a user is able to better focus a direct mailing campaign and reach a wider audience based on specific criteria.

Another advantage, in the case of a job seeker, resides in a single, integrated web based service provider which creates and provides a focused distribution of resumes to potential employers selected from a mailing list.

Yet another advantage resides in saving the job seeker time and costs in direct mailings of resumes, cover letters, and business cards, etc.

Still further advantages will become apparent to those of ordinary skill in the art on reading and understanding the following detailed description.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIGS. 1A and 1B is an illustration of a site map, in accordance with one embodiment.

FIG. 2 is an illustration of a web based service providing web based resume direct, mailing service, in accordance with one embodiment.

FIG. 3 is an illustration of a mailing list web page, in accordance with one embodiment.

FIG. 4 is an illustration of a contact manager web page, in accordance with one embodiment.

FIG. 5 is an illustration of a resume builder web page, in accordance with one embodiment.

FIG. 6 is an illustration of a contact information recordation system, in accordance with one embodiment.

FIG. 7 is an illustration of an experience information recordation page, in accordance with one embodiment.

FIG. 8 is an illustration of an education information entry web page, in accordance with one embodiment.

FIG. 9 is an illustration of a professional association memberships information entry web page, in accordance with one embodiment.

FIG. 10 is an illustration of a hobbies information entry web page, in accordance with one embodiment.

FIGS. 11A AND 11B are illustrations of a cover letter builder web page, in accordance with one embodiment.

FIG. 12 is an illustration of a business card builder web page, in accordance with one embodiment.

FIG. 13 is an illustration of a checkout web page, in accordance with one embodiment.

### DETAILED DESCRIPTION OF THE PREFERRED EMBODIMENTS

Described below is a detailed description of a contacts manager method and system, and a method and system for operating a web based service to create and deliver a direct-mail piece. The exemplary embodiments illustrated and described are directed to a job seeker service which may include delivery of a resume, cover letter and/or other mail piece. However, this disclosure is not limited to job seeker services.

The contacts manager method and system are applicable to various embodiments which include the management of contacts to satisfy personal or business objectives. For example, in the management of contact information related to associates, friends, suppliers, customers, etc. In addition, the web based service to create and deliver a direct-mail piece, as disclosed, provides a method and system capable of delivering one or more mail pieces to various recipients, which may include associates, friends, suppliers, customers, etc.

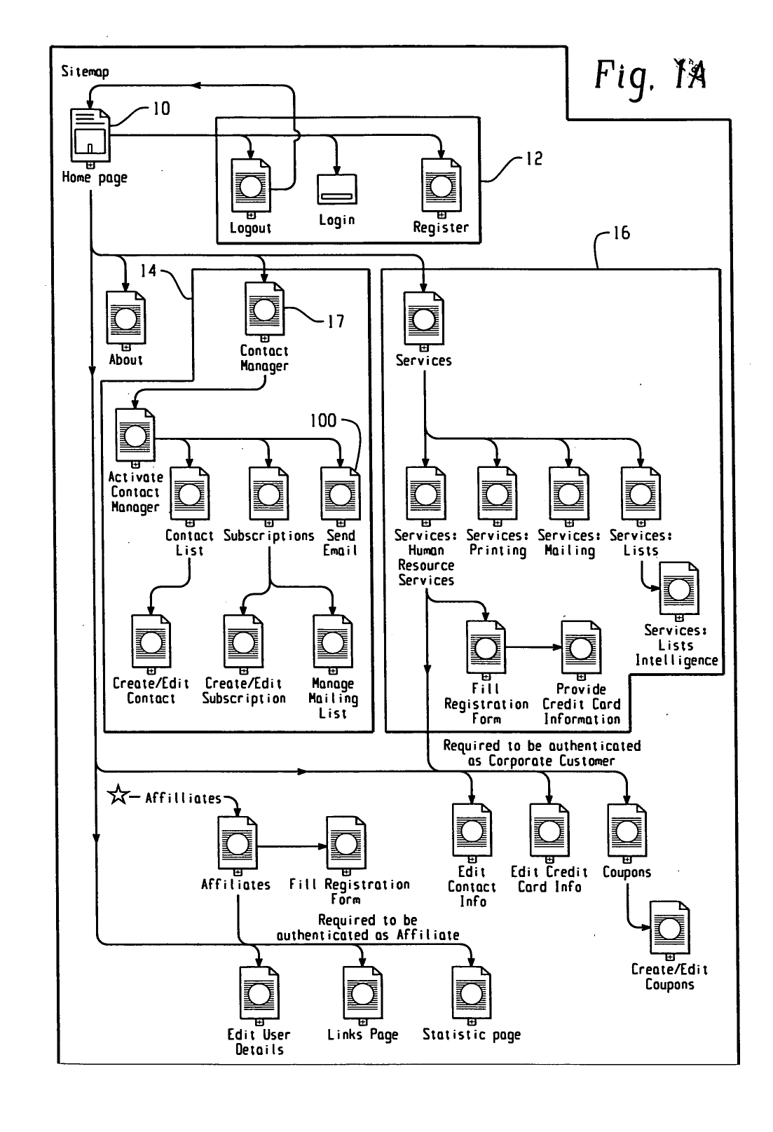

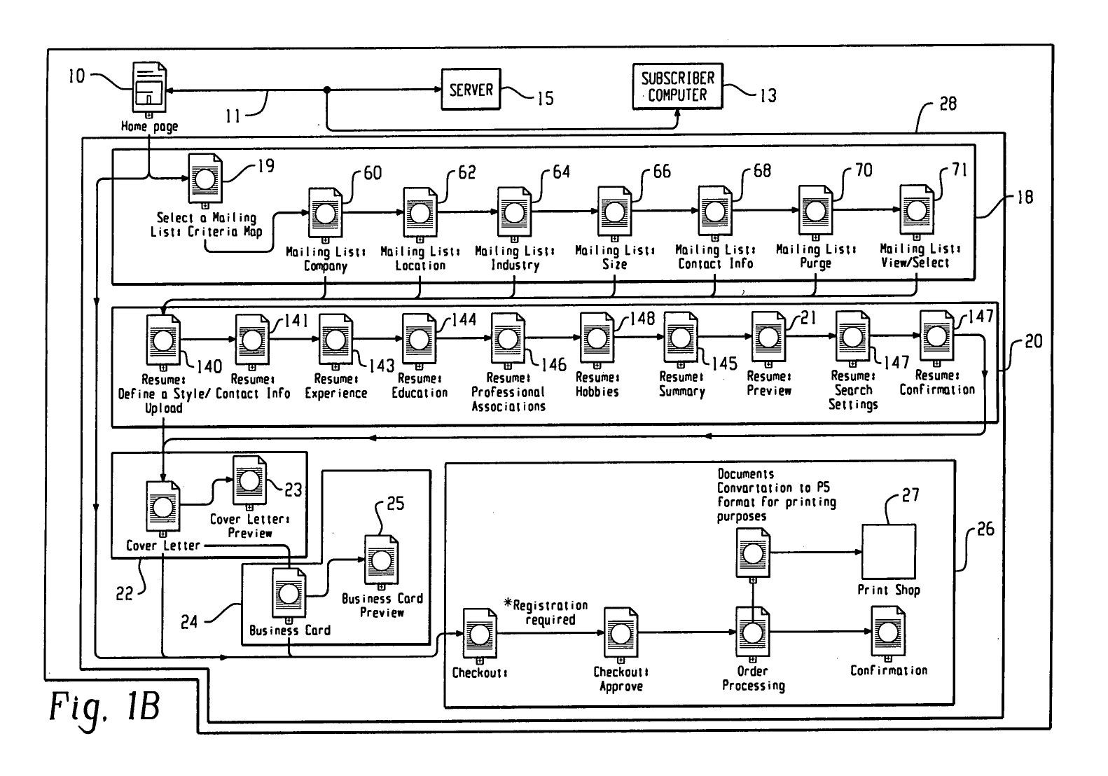

With reference to FIG. 1A and FIG. 1B, a subscriber logs onto the home page 10 of a web based service provider for direct-mail pieces. A subscriber connects to the home page 10 by accessing a server 15 via the internet/intranet 11 with a computer 13. The hardware connection 11 of the server 15 and the subscriber's computer 13 is accomplished by means 11 such as an internet dial up service, internet DSL service, internet broad band cable service, etc. The server 15 stores the data and programs necessary to display the home page 10 to a subscriber in conjunction with the subscriber's computer software. In addition, the server 15 executes the software necessary to provide the web pages and services discussed below. As represented in the site map of FIG. 1A and FIG. 1B, the server 15 executes one or more programs to display the web pages represented by this site map. These web pages are stored in the memory of one or more servers. If more than one server 15 is used to provide storage and access to the web sites, the servers communicate with each other by means 11 of the internet/intranet or other connection protocol. The subscriber's computer 13 requires software to communicate and access a web page located at a server 15. This type of software is readily available and includes means such as Internet Explorer®, Netscape®, etc. As described below in conjunction with a resume services embodiment, this web based service provides for the design of resumes, cover letters, business cards, or other literature and the accurate rendition of designed literature to be printed for delivery or picked up. The literature viewable on-line is an exact replica of the item as it will be printed. This web based service also provides for building a focused mailing list and the management of people contacted in the mailing or follow-up mailings or telephone calls. These and other services can be performed individually or in various orders. The orders described below are exemplary only. In this illustration, the subscriber first uses the contacts system to build a mailing list and manage the contacts by accessing the mailing list building web page by selecting an icon labeled “select mailing list” displayed on the home page 10.

As discussed above and with reference to FIGS. 1A and 1B, the site map of the server configuration represents the web pages stored on a server 15 or servers and available to a subscriber. Available website modules and web pages may include the following: login/logout/registration module 12, contacts manager module 14, services module 16, mailing list module 18, resume builder module 20, cover letter builder module 22, business card builder module 24 and a checkout module 26. As represented in FIG. 1B, the mailing list module 18, resume builder module 20, cover letter builder module 22, business card builder module 24, and checkout module 26 are combinable 28 to provide a step by step process for a subscriber to conduct a job search campaign.

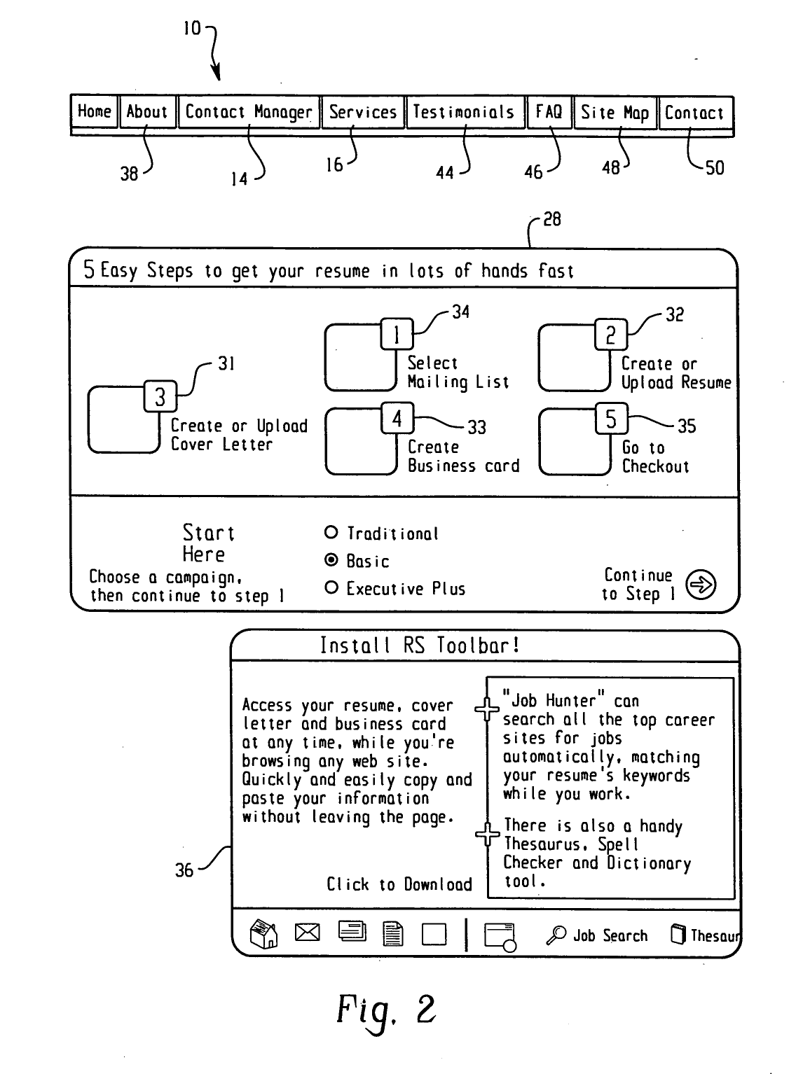

FIG. 2 represents the home web page 10 of a web based resume creation and direct mailing service to conduct a job search campaign. This web page provides the subscriber with access to a variety of on-line tools to build and print a resume 32, build a mailing list 34 for resume delivery with the ability to manage contacts associated with the generated mailing list, build and print cover letters 31 and business cards 33, and delivery 35 of printed items to prospective employees.

As discussed above, according to one embodiment a web based resume creation and direct mailing service is provided. Referring to FIG. 2, a subscriber accesses the home page 10 of the resume service by using a computer 13 with a connection to the appropriate server 15. The subscriber accesses the home page 10 using a computer 13 that is connected to the internet or an intranet 11. A web browser is used to navigate the internet or intranet 11 to communicate with the appropriate server 15. In one embodiment, the web service platform is ASP-Net® by Microsoft. After accessing the home page 10, the subscriber is provided a returning user login and a new user registration on-line procedure. The returning user login module provides services for subscribers whom have forgotten a password and the ability to have a password sent via email. Specifically, the home page 10 can provide the subscriber with a variety of selectable options that include how to use and benefit from being a member of a web based resume direct mailing service, free trial information, email delivery to top recruiters, information regarding URL listing of a members resume, information regarding direct-mail campaigns, privacy protection information, a job hunter meta search engine 36 and access to a step by step web service providing a resume direct mailing campaign 28. In addition, the subscriber can select a web page that provides information about the provided web based resume direct mailing services 38, contact manager services 14, other services 16, testimonials 44, frequently asked questions 46, a site map 48, and contact information 50 regarding the web based resume direct mailing service. Other user selections include legal information, affiliate information, order placement/status and informing a friend.

After a subscriber is successfully logged in, the subscriber can access the contacts manager module 14, a services module 16, and a mailing list module 18 to create, view and deliver direct-mail pieces to people or businesses selected via the mailing list module 18.

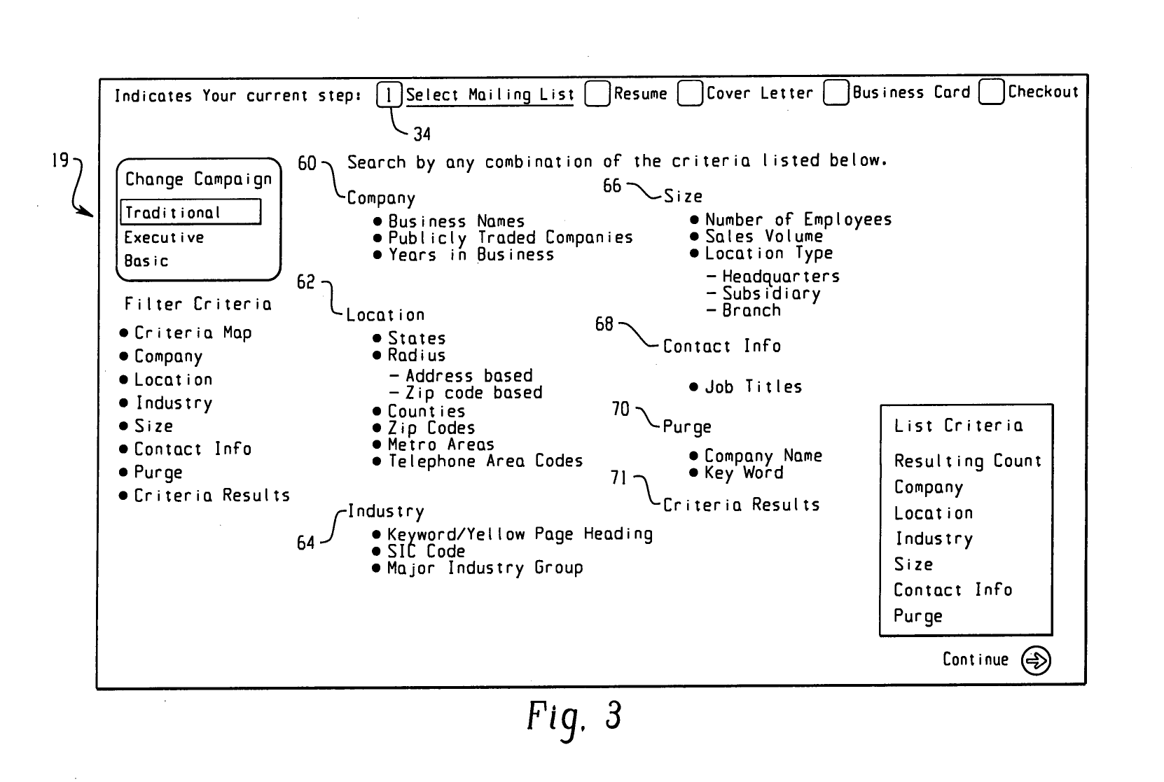

Referring to FIG. 2, illustrated is a home page 10 of a web based resume creation and direct mailing system as displayed on the subscribers computer display. According to one embodiment, a step by step process 28 is provided for a user, i.e. a job seeker, by way of a web page to execute a job search campaign. The subscriber is provided a selection of steps that include building a mailing list 34, creating or uploading a resume 32, creating or uploading a cover letter 31, creating a business card 33 and checking out 35. As illustrated in FIG. 3, step 1 34 provides the subscriber a web page to build a mailing list 19. The mailing list module 18 provides the user with the ability to generate mailing lists of companies and company personnel based on company name 60, location 62, industry 64, size 16 and contact information 68. The mailing list module 18, as represented by the web page 19 illustrated in FIG. 3, provides the subscriber with the ability to view and select lists 71. In addition, a purge list 70 function provides the subscriber with the ability to remove existing lists created by the user at an earlier time. The mailing list module 18 accesses one or more databases to generate a mailing list based on the subscriber's criteria. In addition, the subscriber can customize the mailing list module 19 to limit a user's access to specific data within a database, such as disqualifying a specific company from any mailing list criteria result. In one embodiment of the invention, the mailing list module 18 accesses a Dun and Bradstreet company profile database.

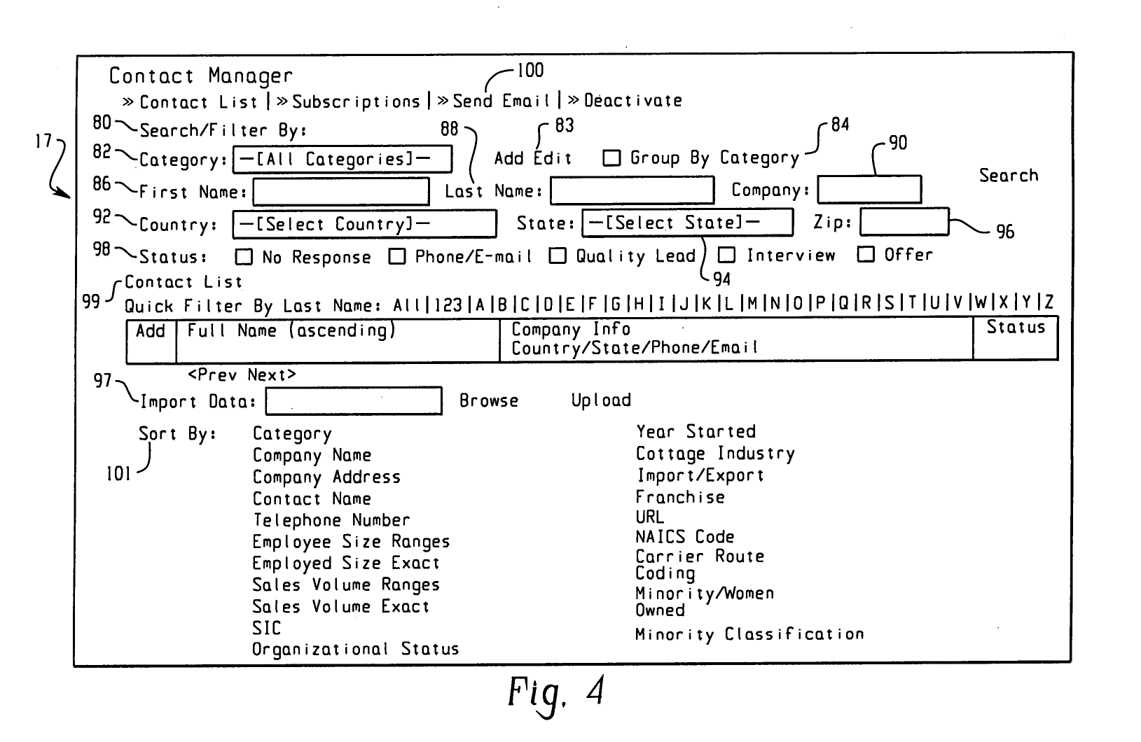

As illustrated in FIG. 4, the contact manager module 14 provides the subscriber a way to manage contacts for people and businesses, including a search/filter 80 based on a criteria of categories 82, category group 84, first name 86, last name 88, company name 90, country 92, state 94, zip code 96, etc. In addition, a sort function 101 further enables a subscriber to sort contacts by criteria such as category 101, contact name 101, company address 101, contact name 101, telephone number 101, employee size ranges 101, employee size exact 101, sales volume ranges 101, sales volume exact 101, SIC 101, organizational status 101, year started 101, cottage industry 101, import/export 101, franchise 101, URL 101, NAICS code 101, carrier route coding 101, minority/women owned 101 and minority classification 101.

According to one embodiment, a status field 98 provides information to a subscriber indicating if a contact or prospective employer responded to a communication, requires a telephone call or email, is considered a quality lead, granted an interview, and/or extended an offer for employment. Data regarding the contact entries is input by a subscriber or imported from a database. In addition, the subscriber can customize the mailing list module 19 to limit a user's access to specific data within a database, such as disqualifying a specific company from any mailing list criteria result.

The contacts manager module 14 provides the subscriber with an on-line secure system to manage contacts. The user creates and edits contacts of professional or personal interest. These contacts are available to the subscriber for generating mailing lists for direct-mailings. In addition, the subscriber has the ability to email 100 the contacts directly.

As illustrated in FIG. 5, step 2 32 provides the subscriber access to a resume builder module 20 web page. The resume builder module 20 web page provides the subscriber with a system of building a resume. This module 20 provides the subscriber with a selection of provided resume design styles 140 or the subscriber can upload an existing resume file 142. Contact information 141, work experience 143, education 144, professional association memberships 146 and hobbies 148 are provided by the subscriber to the resume builder module 20. The subscriber has access to a resume summary 145, a resume preview 21 and a resume confirmation 149 selection. The resume builder has the additional feature of search settings 147. The search settings 147 are used by the user for employment searching. This includes access to meta search engines 36.

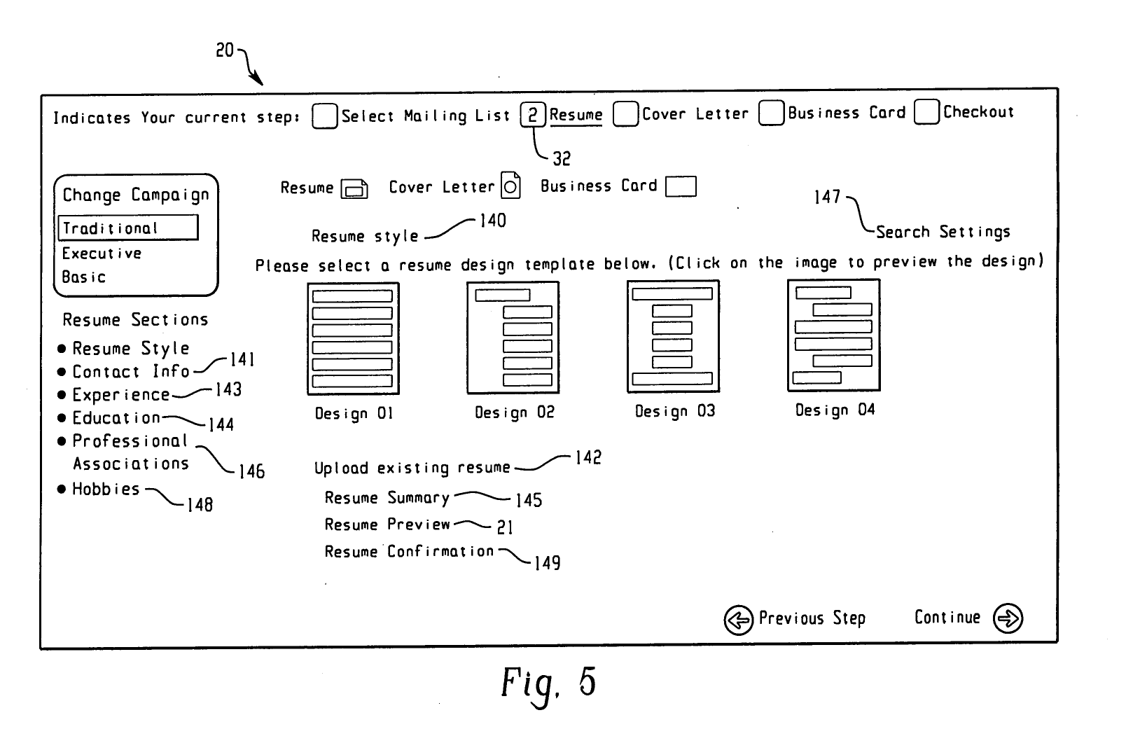

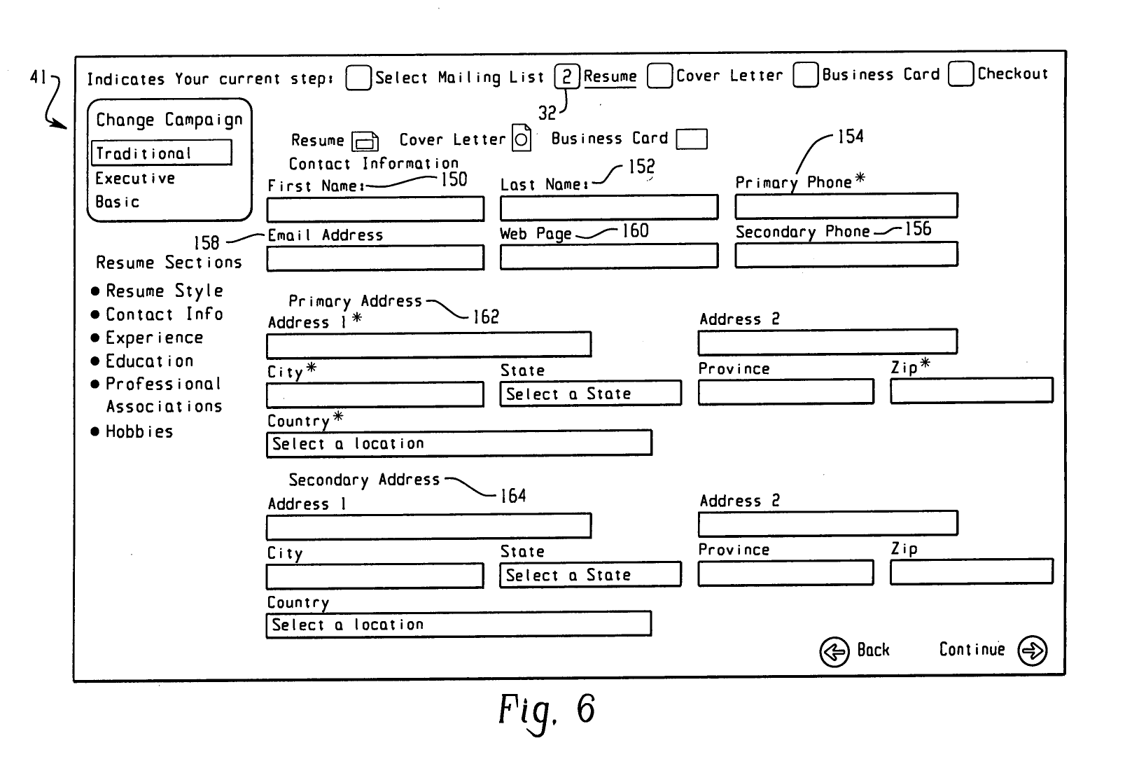

As illustrated in FIG. 6, the subscriber enters contact information 141 by accessing a contact information web page via the resume builder module 20 web page. The subscriber contact information fields available for the subscriber include the subscriber's first name 150, last name 152, primary phone 154, secondary phone 156, email address 158, web page 160, primary addresses 162 and secondary addresses 164.

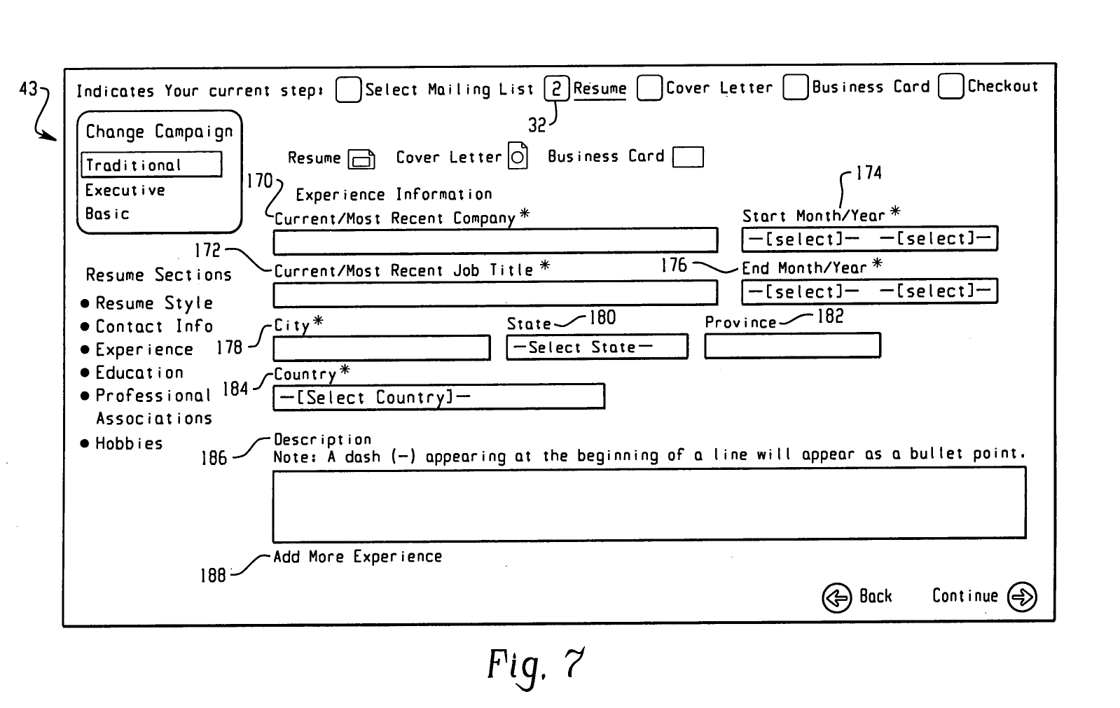

As illustrated in FIG. 7, the subscriber enters experience information 143 by accessing the experience information web page via the resume builder module 20 web page. The subscriber experience information fields available for the subscriber include the current/most recent company of employment 170, the current/most recent job title 172, starting 174 and ending month 176 of most recent/current employment, city of current/most recent employer 178, state of current/most recent employer 180, province of current/most recent employer 182 and country of current/most recent employer 184. In addition, the subscriber experience information 143 fields include a subscriber provided description 186 of the current/most recent experience. After entry of the subscriber current/most recent employment experience, additional experience information 188 can be added.

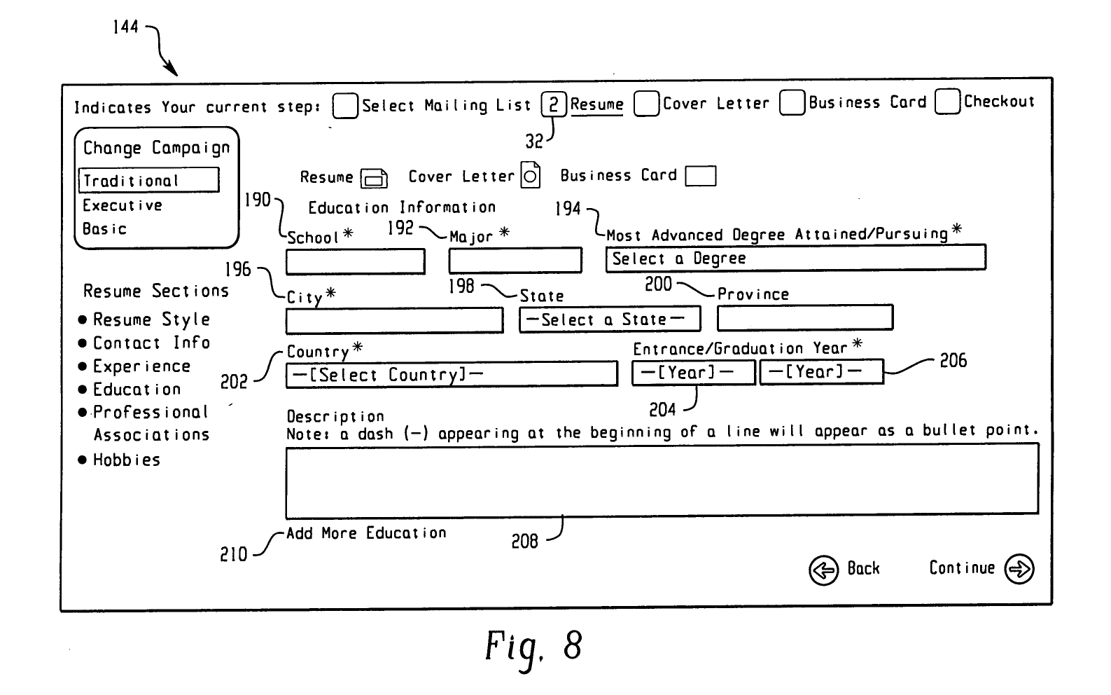

As illustrated in FIG. 8, the subscriber enters education information 144 by accessing the education information web page via the resume builder module web page 20. The user education information fields available include schools attended 190, majors 192, most advance degree attained or pursuing 194, school city 196, school state 198, school province 200, school country 202 and entrance 204 and graduation year 206 of schools attended. In addition, the subscriber education fields include a subscriber provided description 208 of each school attended. After entry of a school attended by the subscriber, additional schools can be added 210.

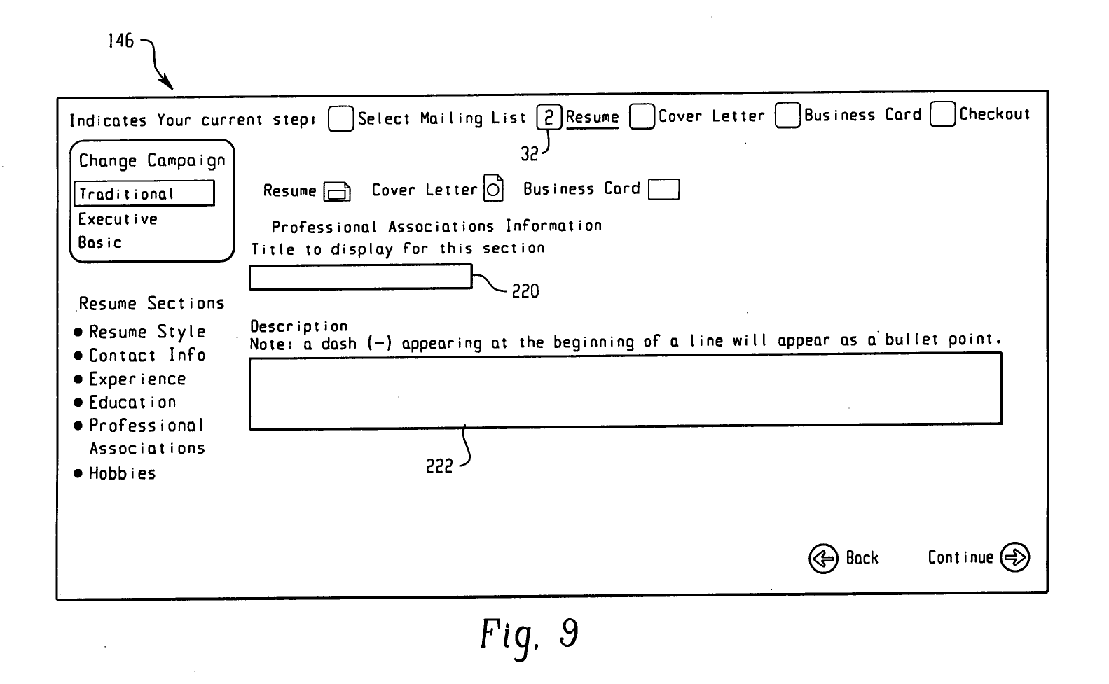

As illustrated in FIG. 9, the subscriber may enter professional association information 146 by accessing the professional association information web page 146 via the resume builder module web page 20. The subscriber professional association information fields available include a title 220 to be displayed on the resume for this information, and a description field 222 regarding the nature of the professional association membership. The description field 222 provides the subscriber with the ability to insert bullet points within the description field 222 of the printed resume. Multiple professional association memberships can be entered by the subscriber.

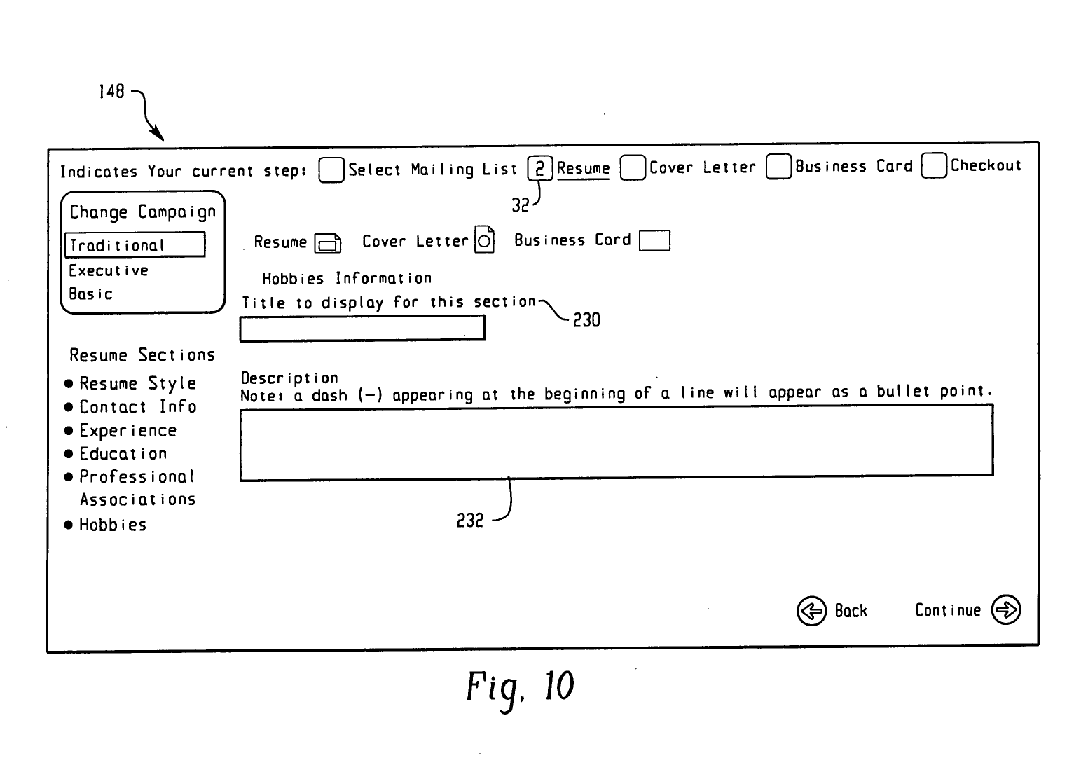

As illustrated in FIG. 10, the subscriber may enter hobby information 148 by accessing the hobby information web page via the resume builder module web page 20. The hobby information fields available include a title 230 to be displayed for the hobby information section of the resume, and a description 232 of the subscriber's hobby. The hobby information field 232 provides the subscriber with the ability to insert bullet points within the hobby information field 232 of the printed resume. Multiple hobbies can be entered by the subscriber.

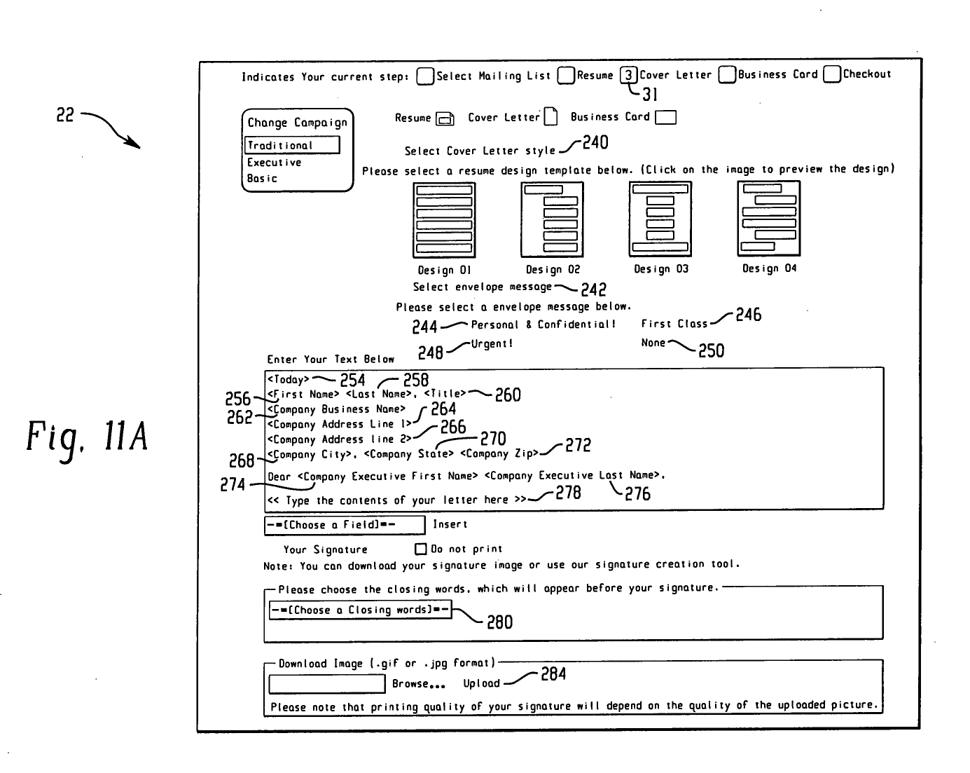

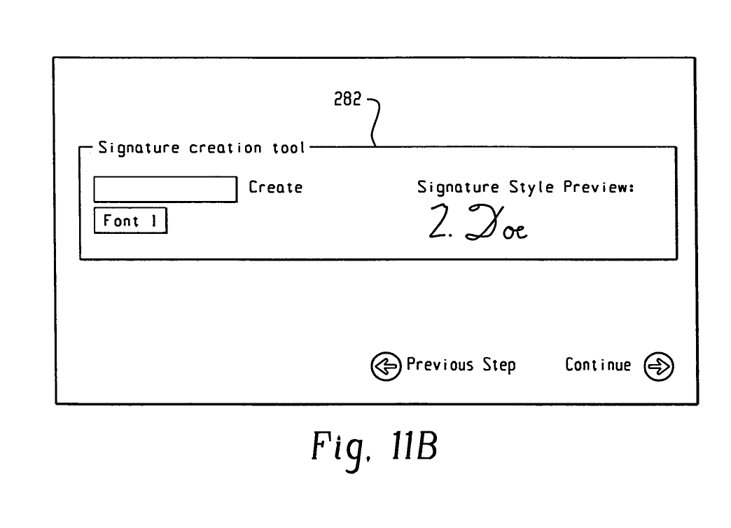

Referring to FIG. 2, FIG. 11A and FIG. 11B, step 3 31 of the process to provide a job search campaign includes creating or uploading a cover letter. The cover letter builder web page 22 provides the subscriber with a system of building a cover letter. This web page provides the subscriber with a selection of provided cover letter design styles 240. The cover letter builder web page 22 provides the subscriber with the ability to select an envelope message 242, such as “personal & confidential” 244, “first class” 246, “urgent!” 248, or none 250. The cover letter builder web page 22 provides a section 252 for the subscriber to enter the text of the cover letter. This section provides a formatted list of relevant fields that enable the subscriber to enter the details of the cover letter. The fields include date 254, first 256 and last 258 name, title 260, company business name 262, company address line 1 264 and line 2 266, company city 268, company state 270 and company zip code 272. In addition, a field is provided for the company executive's first 274 and last name 276 of whom the cover letter is addressed and a field 278 for the contents of the subscriber provided text. The cover letter builder web page 22 also provides the subscriber with the ability to select closing words 280 that will appear before their signature and create 282 or upload 284 a signature file to be printed on the cover letter.

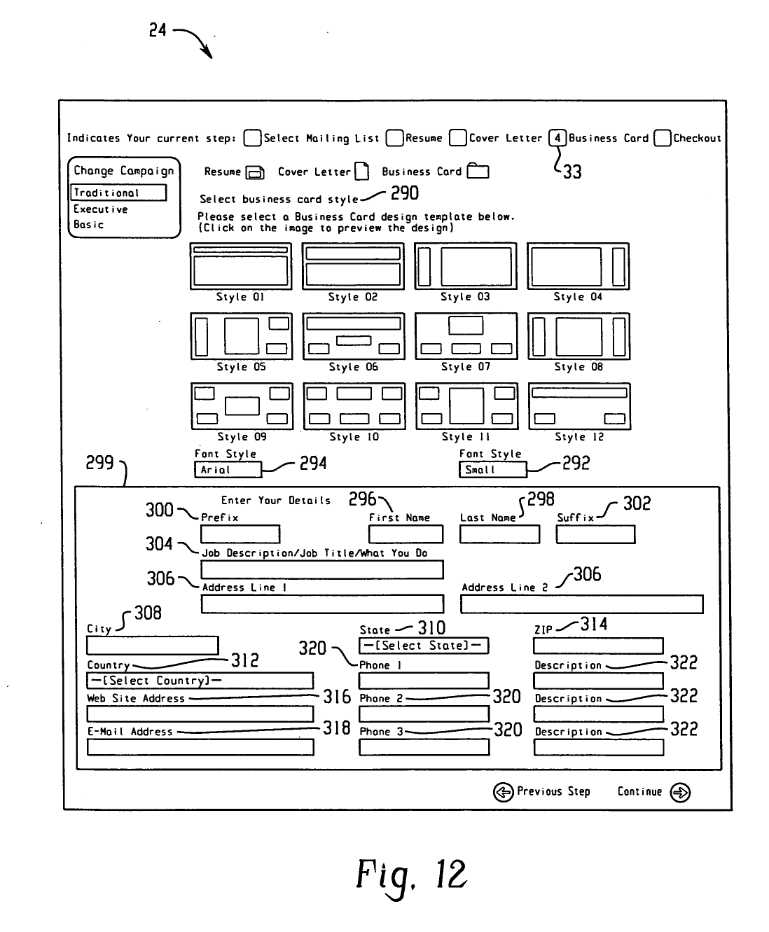

Referring to FIG. 2, FIG. 12A and FIG. 12B, step 4 33 of the process to provide a job search campaign includes a business card creation web page 24 selection 33. The business card web page 24 provides the subscriber with a system of building a business card. This web page provides the subscriber with a selection of provided business card design styles 290. The business card creation web page 24 provides the subscriber with the ability to select a font size 292 and style 294, enter first 296 and last 298 name including a prefix 300 or suffix 302, enter a job title or description 304, and provide the subscriber's address information, including street 306, city 308, state 310, country 312 and zip code 314. Also, the subscriber has the ability to enter a web site address 316, email address 318, and phone numbers 320 with an appropriate description 322, to be printed on the business cards.

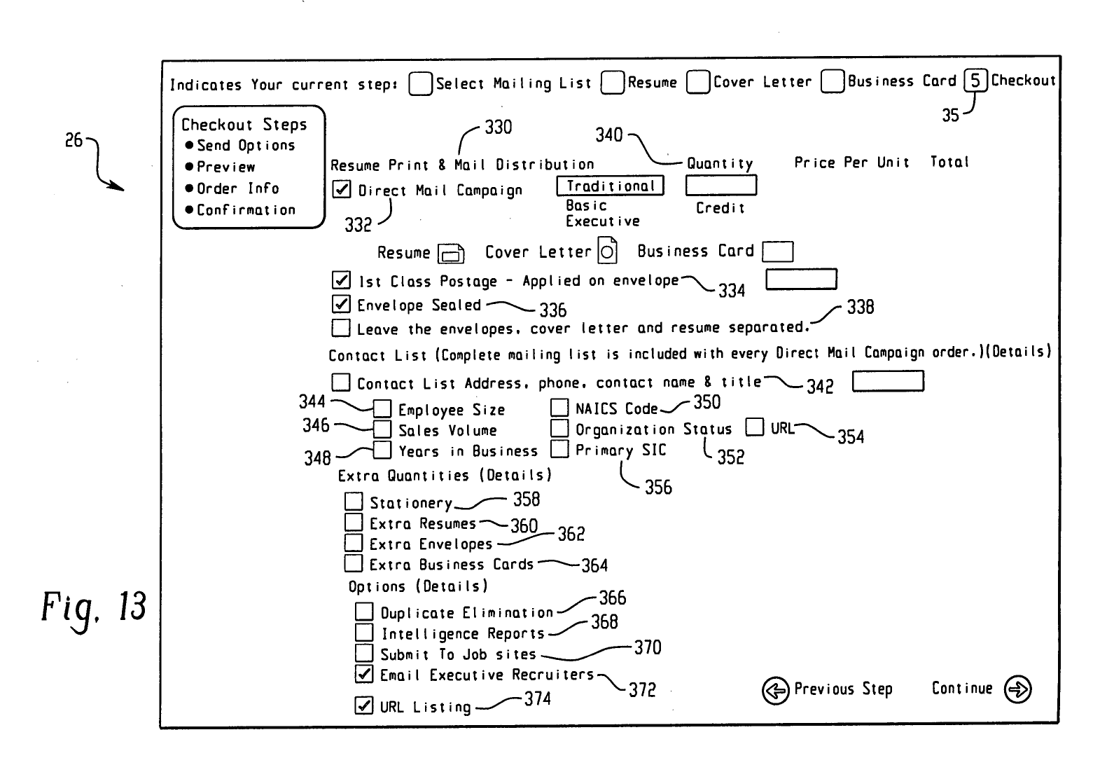

Referring to FIG. 2 and FIG. 13, step 5 35 of the process to provide a job search campaign includes a checkout web page 26. The checkout web page 26 provides the subscriber with a system of procuring literature items created, as discussed above, and distributing the literature items created. This web page provides the subscriber with resume print and distribution services 330 that include selection of a type 332 of direct-mail campaign. Types of direct-mail campaigns include, but are not limited to, traditional, basic and executive packages that provide specific quantities of resumes, cover letters, business cards and mailings, etc. The subscriber can select first class postage 334; envelope sealed or unsealed 336; separated envelopes, cover letter and resume 338; and quantity 340 of items requested. In addition, a contact list selection 342 is provided to the subscriber that can include employee size 344, sales volume 346, years in business 348, NAICS code 350, organization status 352, URL 354 and primary SIC 356. The subscriber can also select specific quantities of stationary 358, resumes 360, envelopes 362 and business cards 364 that are outside the scope of the direct-mail campaign type package selected. Other options available to the subscriber include services to eliminate duplication 366, intelligence reports 368, submission to job sites 370, emailing executive recruiters 372 and URL listings 374. All document or literature to be printed can be previewed by the subscriber before being electronically sent to a print shop 27. Screen to print technology provides an actual rendition of the documents to be printed and previewed by the user. Furthermore, the operation of the checkout module 26 includes formatting of documents to be electronically sent to a print shop for printing and/or delivery to the names and addresses listed on the subscribers mailing list.

In addition to the web based resume direct mailing service described above, the subscriber can access a service module 16 independently of the step by step process associated with the job search campaign described above. The services module 16 provides the subscriber print and mail services, human resource services, intelligence research services and access to the contacts list & on-line management module 14. The corporate human resource services web page provides access for corporate users, such as human resource managers. For example, HR managers who provide ex-employees with a resume service as part of a severance package. Other services available include, but are not limited to, resumes, cover letters, business cards, etc. In addition, other wide-area print distribution and direct mailing is available to the subscriber. The intelligence research services web page provides the subscriber with research services to obtain reports regarding company closings, salaries, recently hired employees and firings, financial disclosures, etc. The contacts list & on-line management web page provides the subscriber with the ability to order a contact list that includes information regarding a company. This information includes employee size, contact name and title, sales, years in business, NAICS code, organization status, URL, etc.

As discussed above, the services module 16 provides the subscriber with access to multiple services regarding direct-mailings. The subscriber prints at locations that have printers with compatible software including exclusive screen to print technology, to provide matching literature as displayed on the subscriber's computer display. These locations can include print shops, copy centers or other print service providers available by agreement. Other services provided to the subscriber include complete mailings, list generation, resume creation/editing, cover letter and business card creation/editing, and screen to print technology. The services module also provides the ability for the subscriber to complete a registration form and provide charge account information for services ordered.

Other features of the web based system to create and deliver a resume are now described with reference to FIG. 2. The home page 10 of the resume creation and delivery service provides the subscriber with the additional feature of access to a toolbar download and install feature 36 to enable the subscriber to access their resume, cover letter and business card anytime the subscriber is browsing other web sites. In addition, the toolbar enables a subscriber to quickly copy and paste information from the subscriber's resume, cover letters, business card, etc. to another website or document. The toolbar provides the subscriber with input fields for selected search engines related to job searching, spell checking, and other such as a thesaurus and dictionary. Toolbar buttons are provided for configuring the toolbar, help and support, job prospects and contact information.

In addition, the home page 10 of the resume creation and delivery service provides the subscriber with access to information about the resume delivery service 38, information regarding frequently asked questions 46 and job information for job hunters as related to direct-mail campaigns. The home page 10 further provides the subscriber with information regarding the privacy policy of the resume delivery service provider.

The invention has been described with reference to the preferred embodiments. Obviously, modifications and alterations will occur to others upon reading and understanding the preceding detailed description. It is intended that the invention be construed as including all such modifications and alterations.

Having thus described the preferred embodiments, the invention is now claimed to be:

1. A method of operating a web based system comprising:
managing a subscriber's personal and business contacts by accessing a contacts manager web page, wherein the contacts web page provides the subscriber with contact information.

2. The method of operating a web based system according to claim 1, wherein the contacts manager web page provides the subscriber with contact information sorted by status and other criteria, such as category, contact name, company address, contact name, telephone number, employee size ranges, employee size exact, sales volume ranges, sales volume exact, SIC, organizational status, year started, cottage industry, import/export, franchise, URL, NAICS code, carrier route coding, minority/women owned and minority classification.

3. The method of operating a web based system according to claim 2, further comprising:
at least one of entering and importing information to the contacts manager web page, including names of people, names of companies, addresses of people and companies, status of previous communications with people and companies, and information describing other attributes of the people or companies.

4. A method of operating a web based system to deliver a direct-mail piece comprising:
logging on to the home page of a web based system;
building a mailing list from a mailing list web page accessed from the home page;
building literature from a literature building web page accessed from the home page or the mailing list web page;
displaying the literature, the displayed literature being an exact replica of the printed literature, before the literature is printed; and
electronically sending the literature to a print shop.

5. A method of operating a web based system to deliver a direct-mail piece according to claim 4, further comprising:
printing the literature at the print shop, as displayed; and
mailing or delivering the printed literature from the print shop.

6. A web based system to create a direct-mail piece comprising:
a means for communicating from a subscriber computer to a server computer that includes a home page;
a means for a subscriber to login from the home page to the web based system;
a means, for the web based system to create and deliver a direct-mail piece to a person or business; and
a means for the web based system to provide a subscriber with a computer display of an exact replica of a direct-mail piece to be delivered, wherein the web based system includes a contacts manager module, a services module and a mailing list module.

7. A web based system to create a direct-mail piece comprising:
a home page, accessible from a subscriber's computer;
a means for a subscriber to login from the home page to the web based system to create, view and deliver literature;
a means for a subscriber to build a mailing list including names and addresses;
a means for creating literature and electronically sending the created literature to the subscriber for display;
a means initiated by the subscriber for sending the created literature electronically for printing literature as displayed.

8. The web based system to create a direct-mail piece according to claim 7, further comprising:
a means for mailing or delivering literature to the names and addresses of listed on said mailing list.

9. The web based system to create a direct-mail piece according to claim 7, wherein the literature creating means includes a means for building a resume.

10. The web based system to create a direct-mail piece according to claim 7, wherein the mailing list builder means includes:
a means for a subscriber to build a mailing list including names and addresses.

11. The web based system to create a direct-mail piece according to claim 10, wherein the mailing list builder means includes:
a contacts or prospective employers list.

12. The web based system to create a direct-mail piece according to claim 11, wherein at least one of the lists of contacts or prospective employers, lists at least one of personal information about contacts, contact dates, projected re-contact dates and response status.

13. The web based system to create a direct-mail piece according to claim 11, wherein the literature creating means includes:
a means for building a cover letter.

14. The web based system to create a direct-mail piece according to claim 13, wherein the cover letter building means includes:
a means for addressing the cover letters with contacts from the contact list.

15. The web based system to create a direct-mail piece according to claim 7, wherein the literature creation means includes:
a means for building a business card.

16. A method of operating a web based system to deliver a direct-mail piece comprising:
logging on to the home page of a web based system;
building a mailing list from a mailing list web page accessed from the home page;
building a resume from a resume building web page accessed from the home page or the mailing list web page;
displaying the resume, the displayed resume being an exact replica of the printed resume, before the resume is printed;
electronically sending the resume to a print shop;
printing the resume as displayed; and
mailing or delivering the resume to the names and addresses listed on the mailing list.

17. The method of operating a web based system to deliver a direct-mail piece according to claim 16, further comprising:
building a mailing list of prospective employers including names and addresses.

18. The method of operating a web based system to deliver a direct-mail piece according to claim 16, further comprising:
building a cover letter from a cover letter web page;
viewing an exact replica of a printed cover letter, before the cover letter is printed;
addressing the cover letter with addresses from the mailing list; and
printing the cover letter.

19. The method of operating a web based system to deliver a direct-mail piece according to claim 16, further comprising:
building a business card from a business card building web page;
viewing an exact replica of a business card, before the business card is printed; and
printing the business card.

20. The method of operating a web based system to deliver a direct-mail piece according to claim 16, further comprising:
managing a subscribers personal and business contacts by accessing a contacts manager web page from the home page, wherein the contacts web page provides the subscriber with contact information.

21. The method of operating a web based system to deliver a direct-mail piece according to claim 20, wherein the contacts web page provides the subscriber with contact information sorted by status and other criteria, such as category, contact name, company address, contact name, telephone number, employee size ranges, employee size exact, sales volume ranges, sales volume exact, SIC, organizational status, year started, cottage industry, import/export, franchise, URL, NAICS code, carrier route coding, minority/women owned and minority classification.

22. The method of operating a web based system to deliver a direct-mail piece according to claim 21, further comprising:
at least one of entering and importing information to the contacts manager web page, including names of people, names of companies, addresses of people and companies, status of previous communications with people and companies, and information describing other attributes of the people or companies.

23. A method of operating a web based system to deliver a direct-mail piece comprising:
logging on to the home page of a web based system;
building a mailing list by selecting an icon on the home page and accessing a mailing list web page;
entering search criteria information within fields of the mailing list web page to generate a list of prospective employers including names and addresses;
building a resume by selecting an icon on the home page or mailing list web page, and accessing a resume building web page;
selecting or uploading a resume template from the resume building web page;
entering, information to be printed on the resume by accessing a web page from the resume building web page;
displaying the resume as constructed from the template and entered information, the displayed resume being an exact replica of the printed resume, before the resume is printed;
building a cover letter by selecting an icon on the home page, the mailing list web page, or the resume builder web page, and accessing a cover letter building web page;
selecting a cover letter template from the cover letter building web page;
entering information to be printed on the cover letter;
selecting an envelope message to be printed on the envelope of the cover letter;
creating or uploading a signature file and entering this file to be printed on the cover letter;
displaying the cover letter and envelope as constructed from the template and entered information, the displayed cover letter being an exact replica of the printed cover letter and envelope, before the cover letter and envelope are printed;
building a business card by selecting an icon on the home page, the mailing list web page, the resume builder web page or the cover letter builder web page, and accessing a business card building web page;
selecting a business card template from the business card building web page;
entering information to be printed on the business card;
displaying the business card as constructed from the template and entered information, the displayed business card being an exact replica of the business card, before the business card is printed;
printing resumes, cover letters and business cards by selecting an icon from the home page, the mailing list web page, the resume builder web page, the cover letter builder web page or the business card building page, and accessing a checking out web page; and
mailing or delivering the resumes, cover letters and business cards to the names and addresses listed on the mailing list.
